(19) United States
(12) Patent Application Publication
(10) Pub. No.: US 2004/0253067 A1
(43) Pub. Date: Dec. 16, 2004

(54) Method of producing a key blank

(76) Inventor: Karl-Heinz Bosch, Esslingen (DE)

Correspondence Address: BACHMAN & LAPOINTE, P.C., 900 CHAPEL STREET, SUITE 1201, NEW HAVEN, CT, 06510, US

(21) Appl. No.: 10/824,976

(22) Filed: Apr. 14, 2004

(30) Foreign Application Priority Data
Apr. 16, 2003 (DE) 103 17 775.2

(51) Int. Cl. B23C 1/16; B23C 3/00

(52) U.S. Cl. 409/132; 409/81; 409/82

(57) ABSTRACT

In a method of producing a key blank from a workpiece (6) using at least one tool, in particular a milling cutter (3′) of a milling device, profiles are incorporated in the workpiece (6) as grooves (2.1′-2.5′), recesses or the like, predetermined, copied or sensed profiles (2.1-2.5) being converted into profiles (2.1′-2.5′) in accordance with the geometry of the tool(s) used, in particular of the milling cutter(s) used.

### BACKGROUND OF THE INVENTION

The present invention relates to a method of producing a key blank from a workpiece using at least one tool, in particular a milling cutter of a milling device.

Different conventional methods of producing key blanks are known. These key blanks are usually produced industrially and then made available to the locksmiths and craftsmen as a blank having milled-in profiles consisting of grooves, recesses, bevels, etc.

The locksmith or the person skilled in the art merely needs to incorporate corresponding serrations and profiled portions at the end face when reproducing a key.

A disadvantage with this procedure is that the locksmith or the person skilled in the art or the dealer must always prepare a multiplicity of key blanks having the profile corresponding to the original key. The very large number of different profiles requires considerable space and storage costs, which is undesirable.

In addition, it takes a considerable amount of time to pick out the matching profile, a factor which is therefore also undesirable.

In other methods, a conventional key blank is produced by copy milling by means of a plurality of disc-type milling cutters designed in accordance with the profile shape.

In this case, a large number of disc-type milling cutters of different design are necessary due to the multiplicity of different profile shapes, grooves—tapering to a point, rounded-off, straight, bevels.

In addition, for each key, it is necessary to insert the correspondingly profiled disc-type milling cutter into the machine once again. The large amount of time required for this and the costs are undesirable.

In further methods, it is known to produce a conventional key blank by a large number of small at least partly stepped copy milling operations using disc-type cutters of narrow design. In the process, the differently shaped profile recesses/grooves are reproduced by the finely stepped configuration. In this case, this step-like machining is very time-consuming. In addition, the one-sided loading of the disc-type milling cutter leads to rapid wear.

The object of the present invention is to provide a method of the type mentioned at the beginning which removes the above-mentioned disadvantages and with which a key blank with profiling matching the lock can be produced in a very short time, if need be also at the place of use, the intention being to considerably minimize the production time. In addition, the storage costs and the tool costs are to be reduced.

### SUMMARY OF THE INVENTION

The foregoing object is achieved by profiles being incorporated in the workpiece as grooves, recesses or the like, predetermined, copied or sensed profiles being converted into profiles in accordance with the geometry of the tool(s) used, in particular of the milling cutter(s) used.

In the case of the present invention, it has proved to be especially advantageous that cross sections of any desired conventional key profiles are present in a recorded stored manner in a milling device, the precise location of corresponding profile recesses in the respective profile surfaces also being filed with regard to a maximum profile width and maximum profile depth.

It is also advantageous if only individual profile parts, preferably grooves or webs, are stored, from which individual profile parts a corresponding key profile can then be composed.

Irrespective of the shape of the profiles, whether they are provided with bevels, are of triangular design or are designed in a radially arched manner in cross section, the maximum depth and the maximum width of the respective profile recesses are recorded with respect to the profile surface and converted into a profile optimized in accordance with the geometry of the disc-type milling cutter used. This profile is then incorporated, in particular milled, in the workpiece using one or more tools, preferably milling cutters, saws, planers, lasers, etc.

In this way, any desired key blank, in which the profiles are milled in the longitudinal direction on one side or both sides, can be produced very quickly.

As a result, all profiles, irrespective of the surface contour, can be converted into profiles which are optimzed with regard to their groove flanks and groove roots in accordance with the geometry of the milling cutter used.

In this case, a disc-type milling cutter having a straight-ended form with right-angled tooth shape can be used. Here, the groove flanks are calculated perpendicularly to the profile surface and the groove roots are calculated parallel to the profile surface in order to ream a profile using as few milling steps as possible, which profile fits into the corresponding cylinder lock passage.

If weakening of the key, or even a fracture of the profile, occurs on account of the calculation of the new optimized profile shape, e.g. if two opposite profile grooves are at a very small distance from one another, the task of the method according to the invention is to calculate the profile recesses at these critical locations in such a way that as much material as possible is retained here during the milling operation.

If a corresponding desired key blank is not filed in the milling device or the like, a key to be reproduced, in particular its profile shape, can be read in by means of a scanning or copying device and can be converted in the manner described above into a profile optimized in accordance with the geometry of the milling cutter. It is also possible to compose the read-in profile from a plurality of filed individual profile parts. This profile can then be milled, ground or embedded in the workpiece. This is likewise to be within the scope of the invention.

### BRIEF DESCRIPTION OF THE DRAWINGS

Further advantages, features and details of the invention follow from the description below of preferred exemplary embodiments and with reference to the drawings, in which:

FIG. 1a shows a schematic cross section through a key profile of a conventional key in a three-dimensional view;

FIG. 1b shows the cross section through the key profile of a conventional key as in FIG. 1a, but not in a three-dimensional view;

FIG. 2a shows the schematic cross section through a key blank according to FIG. 1b reproduced by a copy milling machine fitted with five different disc-type milling cutters, together with five disc-type milling cutters in profile view;

FIG. 3a shows the schematic cross section through a key blank according to FIG. 1b reproduced by a copy milling machine fitted with a narrow disc-type milling cutter, together with a disc-type milling cutter in profile view;

FIG. 4a shows the schematic cross section through an inventive key blank according to FIG. 1b, together with a disc-type milling cutter with cylindrical profiling;

FIG. 4b shows the schematic cross section through an inventive key blank according to FIG. 1b, together with a disc-type milling cutter with trapezoidal profiling;

FIG. 5a shows a schematic cross section through a conventional key profile;

FIG. 5b shows the schematic cross section through an inventive key blank according to FIG. 5a, but before the calculation of the blocking zone to be taken into account;

FIG. 5c shows the schematic cross section through an inventive key blank according to FIG. 5a after completion of the calculation of the blocking zone to be taken into account.

### DETAILED DESCRIPTION

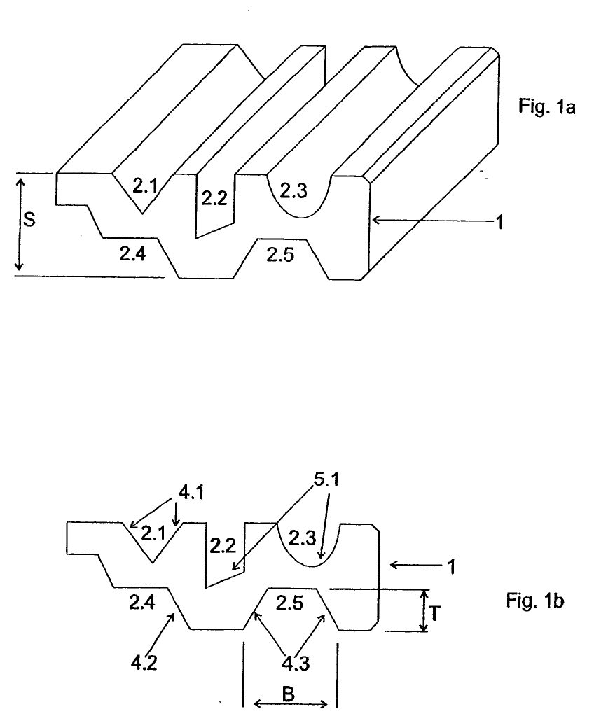

FIGS. 1a and 1b show the profile of a conventional cylinder key (1) with various profile recesses of different shape (2.1-2.5). In order to produce a duplicate key for the associated lock (locking cylinder), the locksmith requires a key blank of corresponding profile, in which serrations are milled at the end face.

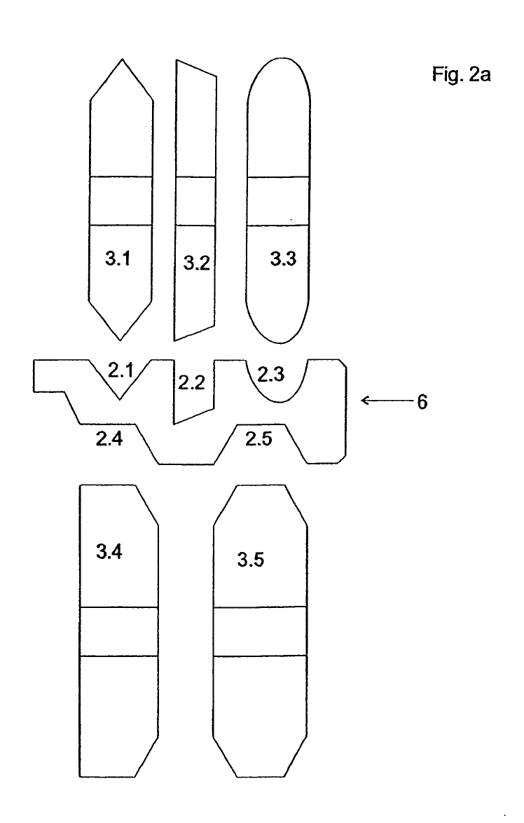

If a key blank with corresponding profile is not available, by means of a copy milling device having milling cutters (3.1-3.5) of different design, as in FIG. 2a, a workpiece (6) can be provided with profile recesses (2.1-2.5) in such a way that a key blank having a suitable profile is obtained. However, this is very expensive on account of the multiplicity of milling cutter forms required.

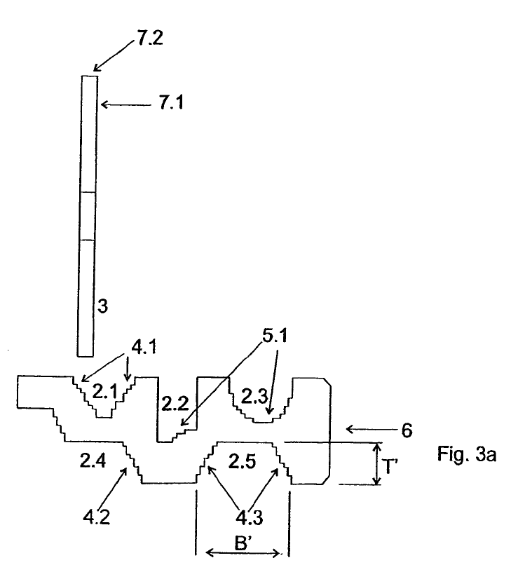

Another possibility is offered by conventional copy milling devices which work with preferably only one milling wheel. In this case, as shown in FIG. 3a, the profile recesses (2.1-2.5) of the original key (1) in FIG. 1b are milled in the workpiece (6) by a finely stepped profile shape. In the process, both the groove flanks (4.1-4.3) and the groove roots (5.1) are stepped in such a way that the shape of the profile in the workpiece (6) largely corresponds to the profile of the key (1). This process takes a very long time due to the large number of finely stepped milling operations required.

In order to produce a suitable key blank quickly and cost-effectively and in such a way as to preserve the tools, the method according to the invention, by means of optical, acoustic or mechanical measuring methods, determines the profile structure of the key (1) to be produced. Furthermore, the maximum depths (T) and the maximum widths (B) of the individual profile recesses (2.1-2.5) are determined at the same time, beforehand or afterward. In addition, space coordinates (not shown in any more detail here), i.e. the points of the key (1) at which corresponding profile recesses are located, are determined.

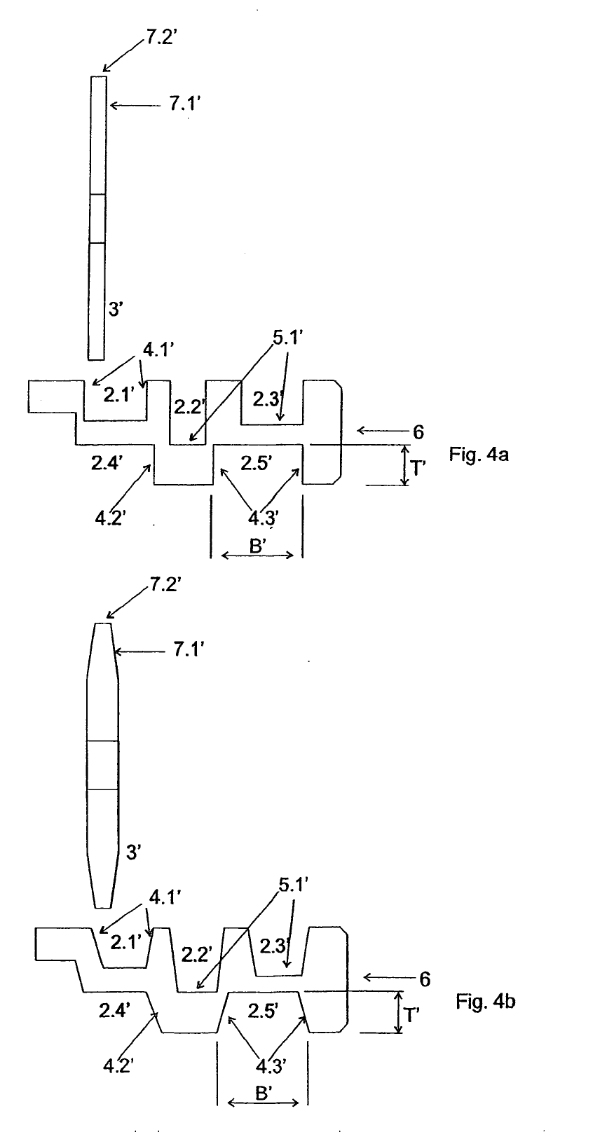

In order to produce a key blank from the workpiece (6) as shown in FIG. 4a, in accordance with the maximum widths (B) and depths (T) of the individual profile recesses (2.1-2.5), a profile is calculated and/or determined from stored profiles and/or composed of individual profile parts, and this profile can be milled extremely quickly with the milling wheel (3′) clamped in the milling machine. In the process, the geometry (7.1′, 7.2′) of the milling wheel (3′) is taken into account.

The workpiece (6) in FIG. 4a is then provided with the determined special profile by milling or grinding. In the exemplary embodiment in FIG. 4a, a milling wheel (3′), for example, is used, the side geometry (7.1′) and the tip geometry (7.2′) of this milling wheel (3′) having a straight-ended form. Matching this, a profile whose profile recesses (2.1′-2.5′) are optimized in accordance with the straight side faces (7.1′) of the milling cutter (3′) and with respect to the straight end face (7.2′) of the milling cutter (3′) is produced in this exemplary embodiment. In this case, the groove flanks (4.1′) are perpendicular to the workpiece surface, so that the groove flanks can be milled very quickly by a single plunge-cut of the straight milling cutter (3′). In addition, the flat groove roots (5.1′) can be milled very quickly, because the complete milling cutter width of the cutter end face (7.2′) comes into use.

Depending on the geometry of the milling cutter, there are different possibilities for the conversion of the profile recesses (2.1-2.5). Thus, FIG. 4b shows a profile optimized for the trapezoidal milling cutter (3′) and having correspondingly inclined groove flanks (4.1′, 4.2′, 4.3′).

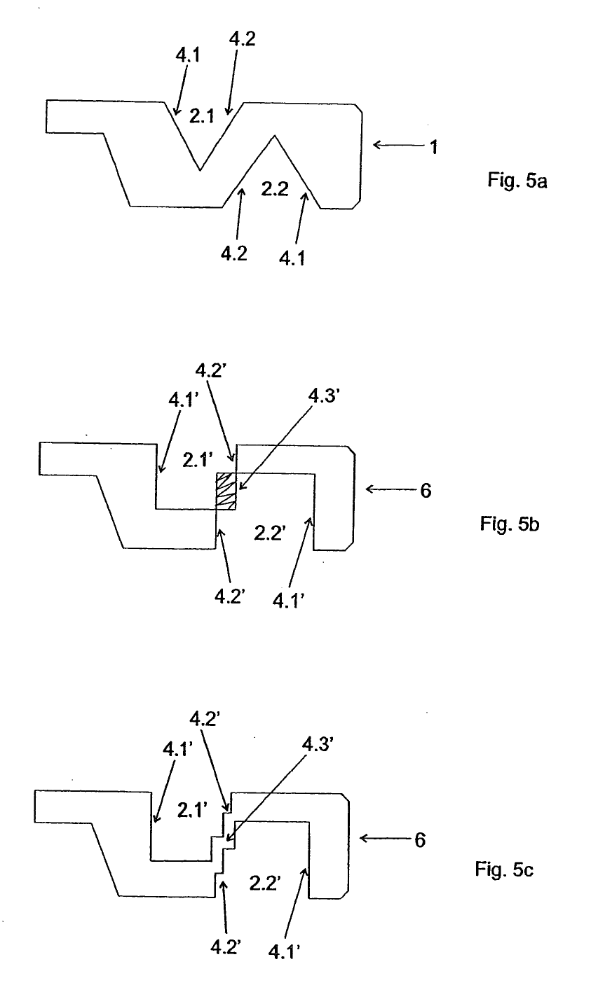

If opposite profile grooves in a key (1) to be produced lie very close together with their groove flanks (4.2) as shown in FIG. 5a, the groove flanks (4.2′) in this region are not strictly calculated according to the milling cutter geometry as depicted in FIG. 5b. The weakening to be expected in the profile or severing of the profile (4.3′) is prevented by the method according to the invention by a maximum profile thickness being calculated by a stepped configuration as in FIG. 5c in the region 4.3′.

1. A method of producing a key blank from a workpiece comprising incorporating a plurality of profiles in a workpiece (6) as grooves (2.1′-2.5′), wherein each of the plurality of profiles is formed in accordance with the geometry of the tool used to form the groove.

2. The method as claimed in claim 1, wherein the grooves (2.1′-2.5′) are milled in a groove width (B′) and groove depth (T′) of a predetermined profile which groove widths (B′) and groove depths (T′) correspond approximately to the groove width (B) and groove depths (T) of the tool forming the groove.

3. The method as claimed in claim 1 or 2, wherein, in order to produce the key blank, the groove flanks (4.1′-4.3′) of the profile recesses (2.1′-2.5′) are incorporated approximately perpendicularly to the workpiece surface.

4. The method as claimed in claim 1 or 2, wherein, in order to produce the key blank, the groove roots (5.1′) of the profile recesses (2.1′-2.5′) are incorporated approximately parallel to the workpiece surface.

5. Method as claimed in claim 1 or 2, wherein, in order to produce the key blank, the groove flanks (4.1′-4.3′) of the profile recesses (2.1′-2.5′) are incorporated approximately in accordance with the angle(s) of the milling cutter sides (7.1′) of the milling cutter(s) used relative to the workpiece surface.

6. The method as claimed in claim 1 or 2, wherein, in order to produce the key blank, the groove roots (5.1′) of the profile recesses (2.1′-2.5′) are incorporated in the workpiece (6) approximately so as to be comparable with the geometry of the milling cutter tip (7.2′).

7. The method as claimed in claim 1, wherein profiles of a conventional key (1) consisting of a plurality of grooves (2.1-2.5) are converted to grooves (2.1′-2.5′), which have a shape optimized in accordance with the geometry of the milling cutter(s) (3′), a width (B′) and a depth (T′) of the profile recesses corresponding approximately to the width (B) and depth (T).

8. The method as claimed in claim 1, wherein a conventional profile of a key (1) is read in via a copying or reading device, the individual grooves (2.1-2.5) or webs, which are also designed as positive or negative bevels or radial profile grooves, being converted into a shape optimized in accordance with the geometry of the milling cutter(s) (3′), with approximately the same width (B, B′) and depth (T, T′), and being milled or incorporated in the workpiece (6).

9. The method as claimed in claim 1, wherein a multiplicity of conventional profiles of keys (1) are stored, each profile being converted into a shape optimized in accordance with the geometry of the milling cutter(s) (3′).

10. The method as claimed in claim 1, wherein a multiplicity of conventional individual profile sections, grooves or recesses are stored, each profile section being converted into a shape optimized in accordance with the geometry of the milling cutter(s) (3′).

11. The method as claimed in claim 1, wherein a key profile is composed of and calculated from a multiplicity of individual profile sections, grooves or recesses.

12. The method as claimed in claim 1, wherein the stored key profiles and/or profile sections are already converted into a shape optimized in accordance with the geometry of the milling cutter(s) (3′).
